(19) United States
(12) Patent Application Publication
(10) Pub. No.: US 2025/0369608 A1
(43) Pub. Date: Dec. 4, 2025

(54) INSECT REPELLANT DEVICE WITH LEVEL INDICATOR

(71) Applicant: PIC Corporation, Linden, NJ (US)

(72) Inventors: Eric Rubel, Westfield, NJ (US); Lawrence E. Bradford, Scotch Plains, NJ (US)

(21) Appl. No.: 19/216,097

(22) Filed: May 22, 2025

Related U.S. Application Data
(60) Provisional application No. 63/653,548, filed on May 30, 2024.

(51) Int. Cl. F21V 33/00; A01M 29/12; A01N 25/18; A01P 17/00; F21S 8/08; F21S 10/04; F21Y 115/10

(52) U.S. Cl. CPC F21V 33/008; A01M 29/12; A01N 25/18; A01P 17/00; F21S 8/081; F21S 10/043; F21Y 2115/10

(57) ABSTRACT

An insect repellant device including a repellant portion, a light portion emitting light and a repellant level indicator.

### CROSS-REFERENCE TO RELATED APPLICATION

The present application claims benefit of and priority to U.S. Provisional Patent Application Ser. No. 63/653,548 filed May 30, 2024 entitled INSECT REPELLANT DEVICE WITH LEVEL INDICATOR, the entire content of which is hereby incorporated by reference herein.

### BACKGROUND

### Field of the Disclosure

The present invention relates to an insect repellant device including a light element providing light and an indicator to indicate an amount of repellant remaining in the device.

### Related

Conventional insect repelling devices typically utilize a chemical repellant which may be a candle or otherwise utilize a flame to vaporize the repellant material to provide an area of vaporized repellant around the device. The use of open flames results both in inconsistent dispersal of repellant as well as the danger of fire. Since many nuisance insects are active at night or in the early evening, conventional devices that utilize a flame provide an advantage in that the use of the flame may also provide light for users to see, however, the use of an open flame provides unreliable light and includes the inherent dangers discussed above.

Further, conventional insect repelling devices do not include a mechanism that indicates an amount of repellant remaining. Users are required to guess the amount of repellant remaining or manually check the repellant level which is labor intensive and inconvenient.

Accordingly, it would be beneficial to provide an insect repelling device the resolves these and other problems.

### SUMMARY

It is an object of the present disclosure to provide an insect repellant device including a light element providing a simulate flame appearance to provide lighting as well as aesthetically pleasing appearance and including an indicator or remaining repellant.

An insect repellant device in accordance with an embodiment of the present disclosure includes: a repellant portion including an insect repellant cartridge and configured to disperse vaporized insect repellant around the insect repellant device; a light portion mounted on the repellant portion, the light portion emitting light; a control circuit operably connected to the repellant portion and the light portion to control activation of the repellant portion to provide vaporized insect repellant and the plurality of flickering light sources to provide light; a repellant sensor configured to provide repellant level information indicative of an amount of insect repellant remaining in the repellant cartridge; and an indicator configured to provide an indication of the amount of insect repellant remaining in the repellant cartridge.

In embodiments, the repellant portion includes: a repellant housing, wherein the insect repellent cartridge is mounted in the repellant housing; a heating element mounted in the repellant housing; the insect repellant cartridge including: a top portion configured to be received in an opening formed in the repellant housing; and a wick extending above the top portion and in contact with the insect repellant, wherein a top of the wick is positioned adjacent to the heating element, wherein the repellant sensor is positioned adjacent to the repellant cartridge.

In embodiments, the control circuit includes a processor and a memory operably connected to the processor, wherein the processor includes processor executable code that when executed by the processor, performs steps of receiving the repellant level information, determining the amount of insect repellant remaining in the insect repellant cartridge and generating a control signal sent to the indicator to provide the indication of the amount of insect repellant remaining in the repellant cartridge.

In embodiments, the repellant sensor is an imaging device and the repellant level information includes image information associated with an image of the repellant cartridge, wherein the image information is provided to the control circuit and processed by the processor to provide the control signal to the indicator to provide the indication of the amount of insect repellant remaining in the repellant cartridge.

In embodiments, the repellant sensor is an imaging device and the repellant level information includes image information associated with an image of the repellant cartridge, wherein the image information is provided to the control circuit and processed to provide a control signal to the indicator to provide the indication of the amount of insect repellant remaining in the repellant cartridge.

In embodiments, the indicator includes a plurality of light elements and one or more light elements is activated to indicate the amount of insect repellant remaining in the repellant cartridge.

In embodiments, the indicator includes a plurality of light elements and the control signal is received and used to activate one or more light elements to provide light of a desired color to indicate the amount of insect repellant remaining in the repellant cartridge.

In embodiments, the indicator includes one or more light elements of different colors and the light elements are activated to provide light of a desired color to indicate the amount of insect repellant remaining in the repellant cartridge.

In embodiments, the repellant sensor comprises a timer that provides active time information associated with an amount of time that the heating element is active to vaporize insect repellent and the active time information is provided to the control circuit and processed to determine the amount of insect repellant remaining in the repellant cartridge.

In embodiments, the repellant sensor comprises a timer that provides active time information associated with an amount of time that the heating element is active to vaporize insect repellant and the control circuit receives the active time information and processes it with evaporation information stored in the memory to determine the amount of insect repellant remaining in the repellant cartridge.

In embodiments, the repellant sensor is a temperature sensor operable to provide temperature information associated with an area adjacent to the repellant cartridge, and the control circuit receives the temperature information and processes it to determine the amount of insect repellant remaining in the repellant cartridge.

In embodiments, the control circuit processes the temperature information to determine whether the temperature information indicates a temperature above a minimum temperature associated with evaporation of the insect repellant.

In embodiments, the repellant sensor is a temperature sensor operable to provide temperature information associated with an area adjacent to the repellant cartridge, and the control circuit receives the temperature information and processes it with evaporation information stored in the memory to determine the amount of insect repellant remaining in the repellant cartridge.

In embodiments, the control circuit processes the temperature information to determine whether the temperature information indicates a temperature above a minimum temperature associated with evaporation of the insect repellant.

In embodiments, the light portion includes a plurality of flickering light sources configured to simulate a flame.

In embodiments, the plurality of flickering light sources include a first group of flickering light sources that are controlled by the control circuit to turn on and off together; and a second group of flickering light sources that are controlled by the control circuit to dim and brighten together, wherein the second group of flickering light sources are positioned below the first group of flickering light sources.

In embodiments, the light portion includes at least one constant light source configured to provide light.

An insect repellant device in accordance with an embodiment of the present disclosure includes: a stand; a post extending upward from the stand; a repellant portion mounted in a top of the post and including an insect repellant cartridge and configured to disperse vaporized insect repellant around the insect repellant device; a light portion mounted on the repellant portion, the light portion emitting light, a control circuit operably connected to the repellant portion and the light portion to control activation of the repellant portion to provide vaporized insect repellant and the plurality of flickering sources to provide light; a repellant sensor configured to provide repellant level information indicative of an amount of insect repellant remaining in the repellant cartridge; and an indicator configured to provide an indication of the amount of insect repellant remaining in the repellant cartridge.

In embodiments, the light portion includes a plurality of flickering light sources configured to simulate a flame.

In embodiments, the plurality of flickering light sources include: a first group of flickering light sources that are controlled by the control circuit to turn on and off together; a second group of flickering light sources that are controlled by the control circuit to dim and brighten together, wherein the second group of flickering light sources are positioned below the first group of flickering light sources.

An insect repellant device includes: a deck clip; a post extending upward from the deck clip; a repellant portion mounted in a top of the post and including an insect repellant cartridge and configured to disperse vaporized insect repellant around the insect repellant device; a light portion mounted on the repellant portion, the light portion emitting light; a control circuit operably connected to the repellant portion and the light portion to control activation of the repellant portion to provide vaporized insect repellant and the plurality of flickering light sources to provide light; a repellant sensor configured to provide repellant level information indicative of an amount of insect repellant remaining in the repellant cartridge; and an indicator configured to provide an indication of the amount of insect repellant remaining in the repellant cartridge.

In embodiments, the light portion includes a plurality of flickering light sources configured to simulate a flame.

In embodiments, the plurality of flickering light sources include: a first group of flickering light sources that are controlled by the control circuit to turn on and off together; a second group of flickering light sources that are controlled by the control circuit to dim and brighten together, wherein the second group of flickering light sources are positioned below the first group of flickering light sources.

### BRIEF DESCRIPTION OF THE DRAWINGS

The above and related objects, features and advantages of the present disclosure will be more fully understood by reference to the following, detailed description of the preferred, albeit illustrative, embodiments of the present invention when taken in conjunction with the accompanying figures, wherein:

FIG. 1 illustrates a cross-sectional view an electric insect repellant device in accordance with an embodiment of the present disclosure;

FIG. 2 illustrates a cross-sectional view of the electric insect repellant device of FIG. 1 including a sensor used to provide an indication of remaining repellant in the device; and

FIG. 3 illustrates an exemplary block diagram of the insect repellant device of FIGS. 1-2 in accordance with an embodiment of the present disclosure.

### DETAILED DESCRIPTION OF THE EXEMPLARY EMBODIMENTS

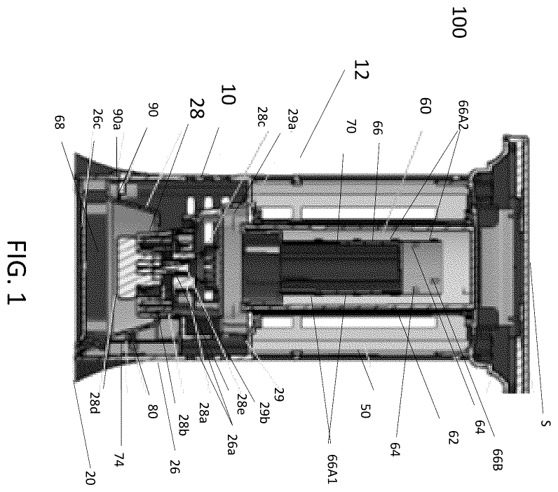

An insect repellant device 100 in accordance with embodiments of the present disclosure is illustrated in the attached drawings. In embodiments, the insect repellant device 100 (see FIG. 1, for example) may include a repellant portion 10 and a light portion 12.

In embodiments, an insect repellant device 100 has a generally rectangular shape, as shown in FIG. 1, for example.

In embodiments, a repellant housing 26 may be mounted on top of a base 20. In embodiments, the repellant housing 26 may include a plurality of vent openings 26a formed in a sidewall thereof. In embodiments, the vent openings 26a are sized to allow vaporized insect repellent material to exit the repellant housing 26 while preventing users from reaching inside the housing 26. In embodiments, the vent openings 26a may be 0.13 inches apart, however, this distance may be larger or smaller.

In embodiments, a heating assembly 28 may be mounted in the repellant housing 26. In embodiments, the heating assembly 28 may include a heating element 28a mounted in a heating housing 28b of the heating assembly. In embodiments, the heating element 28a may be a ceramic heating element. In embodiments, ceramic heating elements offer certain benefits including quick heating, a high heat to size ratio and high energy efficiency. In embodiments, any suitable heating element may be used including an etched foil heater, a band heater or a tubular heater, to name a few. In embodiments, a power terminal 28c may be provided in the heating housing 28b and may be electrically connected to the heating element 28a. In embodiments, the power terminal 28c may be electrically connected to the heating element 28a such that the heating element 28a generates heat. In embodiments, the power terminal 28c may be electrically connected to a power source 68 which provides power to the heating element 28a. In embodiments, power terminal 28c may be, or may be connected to a power source 68. In embodiments, a repellant cartridge 28d may be mounted in the heating housing 28b. In embodiments, the repellant cartridge 28d may hold insect repellant. In embodiments, a wick 28e may extend from a top of the cartridge 28d and may be positioned adjacent to the heating element 28a when the repellant cartridge is mounted in the housing 28b. In embodiments, the repellant cartridge 28d may be removably mounted in the housing 28b. In embodiments, the cartridge 28d may be screwed into the housing 28b. In embodiments, the housing 28b may include an opening 28f configured to receive at least a top portion of the cartridge 28d such that the wick 28e is positioned adjacent to the heating element 28a when the top portion of the cartridge 28d is positioned in the opening 28f. In embodiments, the cartridge 28d may be secured to the housing 28b. In embodiments, the insect repellant may be metofluthrin, however any suitable insect repellant may be used including transfluthrin or essential oils, to name a few. In embodiments, the wick 28e may draw repellant up out of the top of the cartridge 28 adjacent to the heating element 28a where heat from the heating element 28a vaporizes the repellant. The vaporized repellant may flow out through the openings 26a into the area around the repellant device 100 to create an insect free area around the device.

In embodiments, a heating assembly top 29 may be provided above the heating assembly 28. In embodiments, the heating assembly top 29 may include a top disk 29a with a plurality of legs 29b extending downward therefrom spacing the disk 29a from the housing 28b to provide a space for vaporized repellant to fill prior to exiting through the openings 26a.

In embodiments, the repellant housing 26 may include movable bottom 26c that is connected via a hinge and movable between a closed position as illustrated in FIG. 1, for example and an open position in which access to the cartridge 28d is allowed. The bottom 26c of housing 26 may be moved to the open position such that the cartridge 28d can be removed and replaced in the heating element housing 28b.

In embodiments, the light portion 12 may be mounted on top of the repellant portion 10. In embodiments, a screen element 50, may be mounted on top of the housing 26 and extend around a periphery of the light portion 12. In embodiments, the screen element 50 may be substantially transparent. In embodiments, the screen element 50 may be substantially waterproof, or water resistance and may be used to protect the light emitting assembly 60 provided inside the screen element 50.

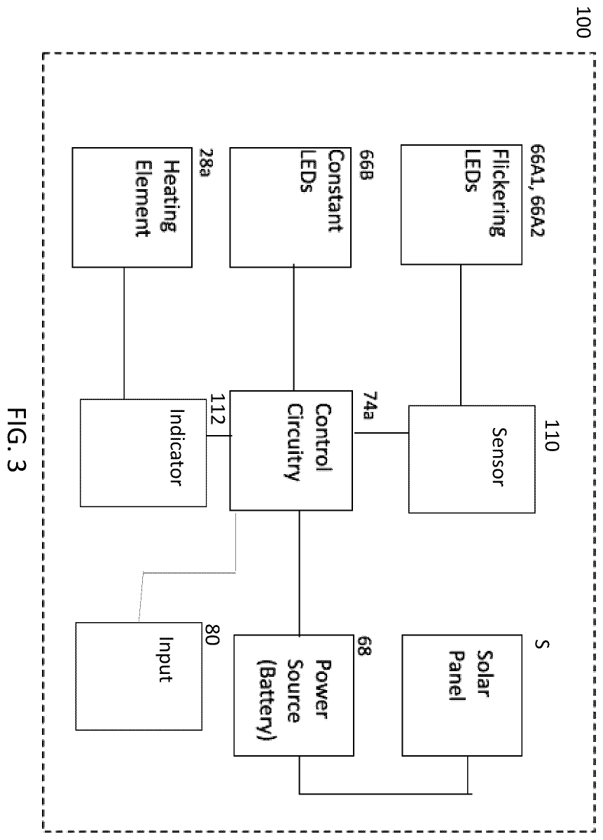

In embodiments, the light emitting assembly 60 may include a cylindrical shade 62 surrounding a light emitting element 64. In embodiments, the light emitting element 64 may include a plurality of light sources 66A1, 66A2 (see FIGS. 1 and 3) which may be mounted on a flexible printed circuit board 66. In embodiments, the board 66 may be mounted on a support 70. In embodiments, the light sources are LEDs 66A1, 66A2 that emit light through the shade 62 which may be tinted or colored to provide the impression of a flame. In embodiments, one or more of the LEDs 66A1, 66A2 may be a different color in order to provide the impression of a flame. In embodiments, the LEDs 66A1 belong to a first group and the LEDs 66A2 belong to a second group. In embodiments, the first group of the LEDs 66A1 may be driven to blink on and off together. In embodiments, the second group of LEDs 66A2 may be driven to brighten and dim in intensity together. In embodiments, the second group of LEDs 66A2 may be positioned below the first group of LEDs 66A1 or vice versa. In embodiments, one or more of the light emitting diodes in the first group of LEDs 66A1 or the second group 66A2 may be of different colors. The combination of the two groups of LEDs, when viewed through the shade 62 which may be tinted or colored as noted above, if desired, provides the impression of a flickering flame behind the screen 50. In embodiments, the shade 62 may be of any desired shape provided that it fits within the screen 50. In embodiments, while LEDs are preferred, other light sources may be used.

In embodiments, the light emitting assembly 60 also provide constant, that is, non-flickering light. In embodiments, the circuit board 66 may include additional constant light sources 66B that may be used to provide a constant light rather than the flickering effect discussed above. In embodiments, the light sources 66B may be of the same color and evenly spaced around the substrate 62. In embodiments, the light sources 66B may be activated together and remain on at the same time to provide for a constant light that does not flicker. In embodiments, the light sources 66B may be white light LEDs. In embodiments, when the light sources 66B are activated, the light sources 66A1, 66A2 are not activated such that the light portion 60 may operate in a constant light mode or a flickering mode. In embodiments, the LEDs 66A1, 66A2 may be used to provide constant light by simply being operated in an alternate state in which they do not blink on and off or dim. In embodiments, where the LEDs 66A1, 66A2 may be used to provide constant light, it may not be necessary to provide the light sources 66B. In embodiments, the flexible circuit board 66 may include additional constant light sources, for example, white light LEDs that may be operated to provide constant light, without flickering, if desired. In embodiments, one or more of the LEDs in the first group of LEDs 66A1 and/or the second group of LEDs 66A2 may be operated in a constant manner to provide constant light without flickering.

In embodiments, the light emitting assembly 60 may include only constant light sources. That is, in embodiments, the light emitting assembly 60 may include only the constant light sources 66B. In such an embodiments, the flickering light sources 66A1, 66A2 may not be included in the light emitting assembly 60.

In embodiments, a circuit board 74 (see FIG. 1) may be provided to hold or provide control circuitry, or a control circuit for the light emitting assembly portion 60 and the repellant portion 10. In embodiments, a power source 68 which may be a battery, may be operatively connected to the PCB 74 and used to power the repellant portion 10 and the light portion 12. In embodiments, the power source 68 may be provided on the circuit board 74. In embodiments, the control circuit may be provided elsewhere and need not be mounted on the circuit board 74. In embodiments, the power source 68 may be a rechargeable battery. In embodiments, the power source 68 may be recharged via a line voltage, if desired via a USB, wireless or other connection. FIG. 1 illustrates an exemplary USB port 90 along with a cover 90a that may be used to cover the port when not being used. In embodiments, the battery may be recharged via any other suitable power source. The power source 68 may be any suitable power source. In embodiments, the power source 68 may be a transformer or transformers that may be used to provide one or more desired voltages to the light portion 12 and repellant portion 10. In embodiments, the power source 68 may be recharged via a solar panel S, which may be mounted on the top of the device, 100. In embodiments, the power source 68 may be operatively connected to the power terminal 28c to provide power and/or for connection to the wire W. In embodiments, the power source 68 may be a transformer connected to the wire W to convert the voltage provided by the wire W to a desired voltage suitable for use with the repellant portion 10 and the light portion 12. In embodiments, the power source 68 may be a terminal or contact connected to the wire W.

In embodiments, the control circuit may include an LED boost circuit used to drive the LEDs 66A1, 66A2 and/or LEDs 66B as well. In embodiments, other driving circuitry may be provided to drive the LEDs 66A1, 66A2 and 66B. As noted above, the two groups of LEDs 66A1, 66A2 are preferably driven in a particular sequence to simulate a flame while the LEDs 66B may be driven to provide constant light. In embodiments, the control circuit 74a may include circuitry to control the repellant portion 10, and specifically the activation of the heating element 28a.

In embodiments, an input device 80 (see FIG. 1) such as a power button or switch may be operable to activate the light portion 12 and/or the repellant portion 10. That is, in embodiments, the light portion 12 may be activated without activating the repellant portion 10. In embodiments, the input device 80 may activate the repellant portion 10 and not the light portion 12. In embodiments, the repellant portion 10 and the light portion 60 may be activated at the same time. In embodiments, the light portion 12 may be activated without the repellant portion 10. In embodiments, the additional LEDs 66B or other light sources may be used to provide for a constant light rather than flickering and may also be controlled by input from the input device 80. In embodiments, these constant light sources 66B may be activated with or without activation of the repellant portion 10. In embodiments, other input devices, other than a power button, may be used to provide input to control the repellant portion 10 and the light portion 12 including the flickering LEDs 66A1, 66A2 and the constant light sources 66B. In embodiments, a light sensor may provide information regarding ambient light levels around the repellant device 100. In embodiments, the light sensor may be provided on or integrated with a transformer, which may be provided externally or in the base 20, 420 as desired. In embodiments, the repellant device 100 may be activated when the ambient light level drops below a threshold level and may turn off when the light level rises above the threshold. In embodiments, the repellant device 100 may be activated such that the light portion 12 is activated to provide either the simulated flame light or the constant light when the ambient light level drops below the threshold level. In embodiments, the repellant portion 10 may be activated to vaporize repellant with or without the flickering LEDs 66A1, 66A2 or the constant light sources 66B activated based on the ambient light level. In embodiments, the light sensor may be a photocell, however, any suitable light sensor device may be used. In embodiments, the light sensor may be provided at any desired portion on the repellant device 100 or as part of a control system operatively connected to the device.

FIG. 3 illustrates an exemplary block diagram of the repellant device 100. In embodiments, the power source 68 may provide power to the heating element 28a, the flickering LEDs 66A1, 66A2 and LEDs 66B as well as the control circuit 74a. The control circuitry, or control circuit, 74a, which may be provided on printed circuit board 74 and may be or include a boost circuit, and/or other circuitry, may drive the flickering LEDs 66A1, 66A2 and LEDs 66B. The control circuit may also control activation of the repellant portion 10, specifically activation of the heating element 28a to vaporize insect repellant. As noted above, the flickering LEDs 66A1, 66A2 may be driven in respective patterns to simulate the appearance of a flickering flame and the LEDs 66B may be activated to provide constant light when desired. In embodiments, the control circuitry 74a 474a may be connected to the input device 80 such as a power button and may drive the repellant portion 10, the flickering LEDs 66A1, 66A2 or constant light LEDs 66B based on input provided by the input device 80. In embodiments, separate control circuitry may be provided and connected to the input device 80 to control the repellant portion 10, the flickering LEDs 66A1, 66A2 and LEDs 66B. In embodiments, the light level information provided by the light sensor may be provided to the control circuit. In embodiments, the control circuitry 74a may include a processor, microprocessor or other control element or component to provide for control of the repellant portion 10, the flickering LEDs 66A1, 66A2 and LEDs 66B. In embodiments, control of the repellant portion 10, the flickering LEDs 66A1, 66A2 and LEDs 66B may be based on both input from the power button 80 and the light sensor. In embodiments, the input device 80 may be pressed once, or placed in a first position, to enter a light monitoring mode in which power is provided to one or more of the repellant portion 10, the flickering LEDs 66A1, 66A2 and LEDs 66B when the light information indicates a light level below a threshold based on input form the sensor. In embodiments, one or more of the repellant portion 10, the flickering LEDs 66A1, 66A2 and LEDs 66B may be deactivated when the light level rises above the threshold. In embodiments, pushing the button 80 again, or putting it in a second position, may directly activate one or more of the repellant portion 10, the flickering LEDs 66A1, 66A2 and LEDs 66B without consideration of the light level information. In embodiments, as noted above, each of the repellant portion 10, the flickering LEDs 66A1, 66A2 and LEDs 66B may be activated independently, if desired, based on operation of, or the position of, the power button 80 and/or light level information provided by the light sensor. In embodiments, as noted above, other input elements may provide information to control the repellant portion 10, the flickering LEDs 66A1, 66A2 and LEDs 66B. In embodiments, the repellant device 100, 200, 300, 400 may be placed in an off mode in which all of the repellant portion 10, the flickering LEDs 66A1, 66A2 and LEDs 66B are deactivated and stay that way regardless of light sensor information until activation of the power button 80 or another input.

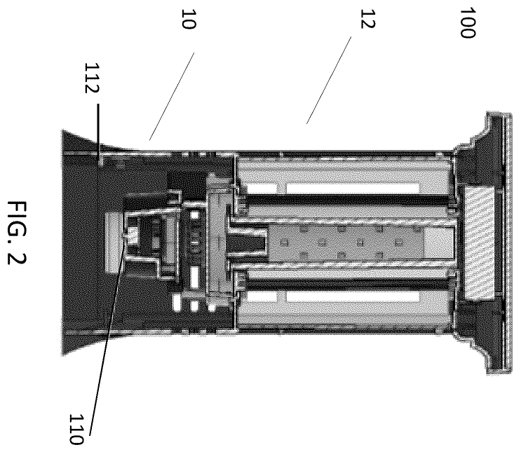

As indicated in FIG. 2, for example, the device 100 may also include one or more repellant sensors 110 configured to provide repellant level information associated with an amount of repellant remaining in the repellant cartridge 28d. In embodiments, the control circuit 74a may be configured to monitor a repellant level in the cartridge 28d based on receipt of the repellant level information. In one embodiment, the repellant sensor 110 may simply be a timer that tracks the active time of the repellant portion 10. Once the time reaches a certain value a signal may be provided to activate an indicator 112 (FIG. 2) to signal that repellant has run out, or is low or otherwise indicate a level of repellant remaining.

In embodiments, the active time provided by the sensor 110 may be used in combination with an evaporation rate of the insect repellent to determine the amount of repellant remaining the cartridge 28d as well as the value that triggers the signal. In embodiments, the control circuit 74a may receive the active time information and may receive or retrieve the evaporation rate information and total amount information, or prior repellant level information, and determine the value that will trigger the signal. In embodiments, the control circuit 74a may also estimate the amount of repellant remaining and the signal may be triggered when the estimate of the amount of repellant dops below a minimum amount. In embodiments, the time value or the minimum amount may be provided by input provided by a user via input device 80, for example. In embodiments, the active time value or the minimum amount may be calculated by the control circuit 74a.

In embodiments, the sensor 110 may be or include a temperature sensor to provide temperature information associated with the heating element 28a or the area around it. In embodiments, the control circuit 74a may receive the temperature information associated with the heating element. In embodiments, the temperature information may also be used in combination with the evaporation rate information to determine the amount of repellant remaining in the cartridge 28d and or the active tie value that triggers the signal. In embodiments, the control circuit 74a may determine when the temperature has reached a threshold and stays above the threshold, for example, a level sufficient to evaporate the repellant. In embodiments, the type of repellant used may be taken into account when determining the remaining amount of repellant, the active time value or the minimum amount as some repellants may evaporate faster than others. In embodiments, such differences will generally be reflected in the evaporation rate information. In embodiments, the size of the cartridge 28d may also be taken into account which may be reflected in the total amount information which may indicate a maximum repellant level. In embodiments, the total amount information may be pre-set or may be entered, via input 80, for example, to account for different beginning amounts of repellant which may be associated with an evaporation temperature of the repellant. In embodiments, a prior repellant level may be retrieved to account for prior evaporation. In embodiments, the sensor 110 may be provided adjacent the heating element 28a to provide an indication of ambient temperature at the wick which may be more accurate in determining the amount of repellant consumed.

In embodiments, the sensor 110 may be an optical device that may be used to provide image information associated with the cartridge 28d which may indicate a visible level of repellant in the cartridge 28d. In embodiments, the image information may be provided to the control circuit 74a and processed to determine an amount of repellant remaining in the cartridge 28d. In embodiments, the sensor 110 may be positioned in whole or in part in the cartridge 28d and configured to provide an indication of the repellant level in the cartridge. In embodiments, the sensor 110 may be a digital imaging device.

In embodiments, the indicator 112 may include one or more light elements, for example, light emitting diodes (LEDs) and may activate the one or more LED's to indicate the amount of repellant remaining in the cartridge 28d. In embodiments, the number of lights activated may indicate and track the amount of repellant remaining in the cartridge 28d. In embodiments, for example, when the cartridge 28d is full, four LEDs maybe illuminated with LEDs going off as the level drops. In embodiments, when the cartridge 28d is full, no light sources may be illuminated and light sources may be activated as the repellant level drops. In embodiments, the illumination of each light element may indicate percentage drop, 25% for example when 4 light sources are used. In embodiments, more or fewer light sources may be used. In embodiments, the indicator 112 may include a single light element that is activated when the amount of repellant remaining in the cartridge falls below a desired minimum level. In embodiments, the indicator 112 may include a light source that flashes when the level drops below a certain level. In embodiments, the indicator 112 may include light elements of different colors and may activate different colors to indicate the amount of repellant remaining in the cartridge 28d. In embodiments, the indicator 112 may be a display that illustrates images or numbers that may be used to indicate the amount of repellant remaining in the cartridge 28d.

In embodiments, the indicator 112 may include a transducer to provide an audible indication of repellant level, such as an audible alert. In embodiments, the indicator 112 may include or receive audio information, for example, a recording of a message that may be reproduced by the transducer. In embodiments, the sound may be reproduced when a level of repellant drops below a desired minimum.

In embodiments, the indicator 112 (or control circuit 74a) may send a wireless message, for example via Bluetooth or a cellular network regarding the repellant to a network. In embodiments, the wireless message may be sent to a user electronic device such as a cellular telephone smartphone, laptop computer or other electronic device to alert the user. In such a case, the device 100 may include a wireless transceiver.

In embodiments, the control circuit 74a may be or may include a processor and memory operably connected thereto. In embodiments, the memory may include processor executable instructions, that when executed by the processor perform steps of selectively activating the repellant portion 10, the lighting element 12 and for receiving information from the sensor 110, determining at least one of: the active time value, determining a level of repellant remaining in the cartridge 28d and providing control signals to the indicator 112. In embodiments, the control circuit 74a may include a wireless transceiver configured to send and receive information to an external electronic device. In embodiments, the processing of the active time information, temperature information or optical information may take place in the external electronic device and the control circuit 74a may receive control signals, or other instructions, based on the processing to operate the indicator. In embodiments, the control circuit 74a may include or be implemented using an integrated circuit including but not limited to an ASIC.

One advantage of the repellant device 100 is that it repels insects by providing a substantially pest free area around the device 100 and provides an indication of the amount of repellant remaining visible from an exterior. In embodiments, one advantage of the device 100 is that it may be recharged via solar cells S which may allow for powering the lighting element 12 and the replant portion 10 without the need for an external power source. For convenience, the device 400 may be recharges via a USB port. Finally, the device 100 includes sensors to monitor and provide information on the remaining repellant level including an indicator to alert users to a low repellant level such that the device will not run out of repellant.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. An insect repellant device comprising:
a repellant portion including an insect repellent cartridge and configured to disperse vaporized insect repellent around the insect repellant device;
a light portion mounted on the repellant portion, the light portion emitting light;
a control circuit operably connected to the repellant portion and the light portion to control activation of the repellant portion to provide vaporized insect repellent and the plurality of flickering light sources to provide light;
a repellant sensor configured to provide repellant level information indicative of an amount of insect repellant remaining in the repellant cartridge; and
an indicator configured to provide an indication of the amount of insect repellant remaining in the repellant cartridge.

2. The insect repellant device of claim 1, wherein the repellant portion comprises:
a repellant housing, wherein the insect repellent cartridge is mounted in the repellant housing;
a heating element mounted in the repellant housing;
the insect repellant cartridge including:
a top portion configured to be received in an opening formed in the repellant housing; and
a wick extending above the top portion and in contact with the insect repellant, wherein a top of the wick is positioned adjacent to the heating element,
wherein the repellant sensor is positioned adjacent to the repellant cartridge.

3. The insect repellant device of claim 1, wherein the control circuit includes a processor and a memory operably connected to the processor, wherein the processor includes processor executable code that when executed by the processor, performs steps of receiving the repellant level information, determining the amount of insect repellant remaining in the insect repellant cartridge and generating a control signal sent to the indicator to provide the indication of the amount of insect repellant remaining in the repellant cartridge.

4. The insect repellant device of claim 3, wherein the repellant sensor is an imaging device and the repellant level information includes image information associated with an image of the repellant cartridge, wherein the image information is provided to the control circuit and processed by the processor to provide the control signal to the indicator to provide the indication of the amount of insect repellant remaining in the repellant cartridge.

5. The insect repellant device of claim 1, wherein the repellant sensor is an imaging device and the repellant level information includes image information associated with an image of the repellant cartridge, wherein the image information is provided to the control circuit and processed to provide a control signal to the indicator to provide the indication of the amount of insect repellant remaining in the repellant cartridge.

6. The insect repellant device of claim 1, wherein the indicator includes a plurality of light elements and one or more light elements is activated to indicate the amount of insect repellant remaining in the repellant cartridge.

7. The insect repellant device of claim 3, wherein the indicator includes a plurality of light elements and the control signal is received and used to activate one or more light elements to provide light of a desired color to indicate the amount of insect repellant remaining in the repellant cartridge.

8. The insect repellant device of claim 1, wherein the indicator includes one or more light elements of different colors and the light elements are activated to provide light of a desired color to indicate the amount of insect repellant remaining in the repellant cartridge.

9. The insect repellant device of claim 2, wherein the repellant sensor comprises a timer that provides active time information associated with an amount of time that the heating element is active to vaporize insect repellant and the active time information is provided to the control circuit and processed to determine the amount of insect repellant remaining in the repellant cartridge.

10. The insect repellant device of claim 3, wherein the repellant sensor comprises a timer that provides active time information associated with an amount of time that the heating element is active to vaporize insect repellant and the control circuit receives the active time information and processes it with evaporation information stored in the memory to determine the amount of insect repellant remaining in the repellant cartridge.

11. The insect repellant device of claim 1, wherein the repellant sensor is a temperature sensor operable to provide temperature information associated with an area adjacent to the repellant cartridge, and the control circuit receives the temperature information and processes it to determine the amount of insect repellant remaining in the repellant cartridge.

12. The insect repellant device of claim 11, wherein the control circuit processes the temperature information to determine whether the temperature information indicates a temperature above a minimum temperature associated with evaporation of the insect repellant.

13. The insect repellant device of claim 3, wherein the repellant sensor is a temperature sensor operable to provide temperature information associated with an area adjacent to the repellant cartridge, and the control circuit receives the temperature information and processes it with evaporation information stored in the memory to determine the amount of insect repellent remaining in the repellant cartridge.

14. The insect repellant device of claim 13, wherein the control circuit processes the temperature information to determine whether the temperature information indicates a temperature above a minimum temperature associated with evaporation of the insect repellant.

15. The insect repellant device of claim 1, wherein the light portion includes a plurality of flickering light sources configured to simulate a flame.

16. The insect repellant device of claim 15, wherein the plurality of flickering light sources include:
a first group of flickering light sources that are controlled by the control circuit to turn on and off together; and
a second group of flickering light sources that are controlled by the control circuit to dim and brighten together,
wherein the second group of flickering light sources are positioned below the first group of flickering light sources.

17. The insect repellant device of claim 1, wherein the light portion includes at least one constant light source configured to provide light.

18. An insect repellant device comprising:
a stand;
a post extending upward from the stand;
a repellant portion mounted in a top of the post and including an insect repellant cartridge and configured to disperse vaporized insect repellant around the insect repellant device;
a light portion mounted on the repellant portion, the light portion emitting light;
a control circuit operably connected to the repellant portion and the light portion to control activation of the repellant portion to provide vaporized insect repellent and the plurality of flickering light sources to provide light;
a repellant sensor configured to provide repellant level information indicative of an amount of insect repellant remaining in the repellant cartridge; and
an indicator configured to provide an indication of the amount of insect repellant remaining in the repellant cartridge.

19. The insect repellant device of claim 18, wherein the light portion includes a plurality of flickering light sources configured to simulate a flame.

20. The insect repellant device of claim 19, where the plurality of flickering light sources include:
a first group of flickering light sources that are controlled by the control circuit to turn on and off together;
a second group of flickering light sources that are controlled by the control circuit to dim and brighten together,
wherein the second group of flickering light sources are positioned below the first group of flickering light sources.

21. An insect repellant device comprises:
a deck clip;
a post extending upward from the deck clip;
a repellant portion mounted in a top of the post and including an insect repellant cartridge and configured to disperse vaporized insect repellent around the insect repellant device;
a light portion mounted on the repellant portion, the light portion emitting light;
a control circuit operably connected to the repellant portion and the light portion to control activation of the repellant portion to provide vaporized insect repellant and the plurality of flickering light sources to provide light;
a repellant sensor configured to provide repellant level information indicative of an amount of insect repellant remaining in the repellant cartridge; and
an indicator configured to provide an indication of the amount of insect repellant remaining in the repellant cartridge.

22. The insect repellant device of claim 21, wherein the light portion includes a plurality of flickering light sources configured to simulate a flame.

23. The insect repellant device of claim 22, where the plurality of flickering light sources include:
a first group of flickering light sources that are controlled by the control circuit to turn on and off together;
a second group of flickering light sources that are controlled by the control circuit to dim and brighten together,
wherein the second group of flickering light sources are positioned below the first group of flickering light sources.
